(19) United States
(12) Patent Application Publication
(10) Pub. No.: US 2016/0057539 A1
(43) Pub. Date: Feb. 25, 2016

(54) METHOD FOR RECORDING AND RECONSTRUCTING THREE-DIMENSIONAL SOUND FIELD

(71) Applicant: National Tsing Hua University, Hsinchu (TW)

(72) Inventors: Mingsian R. BAI, Hsinchu (TW); Yi-Hsin HUA, Hsinchu (TW)

(21) Appl. No.: 14/572,564

(22) Filed: Dec. 16, 2014

(30) Foreign Application Priority Data
Aug. 20, 2014 (TW) 103128563

(51) Int. Cl. H04R 5/027; H04R 5/04

(52) U.S. Cl. CPC H04R 5/027; H04R 5/04

(57) ABSTRACT

A method for recording and reconstructing a three-dimensional (3D) sound field, wherein a microphone array is established in a 3D sound field to track and locate sound sources in the 3D sound field and retrieve corresponding sound source signals. A plurality of control points is established inside an area where the 3D sound field is to be reconstructed. The control points are used to establish relational expressions of the sound source signals, the 3D sound field, a reconstructed sound field, and reconstructed sound source signals. The reconstructed sound source signals are obtained via solving the relational expressions and input into a speaker array arranged outside the area to establish the reconstructed sound field in the area. The present invention truly records the 3D sound field without using any extra transformation process and replays the reconstructed sound field with a larger sweet spot in higher fidelity.

### FIELD OF THE INVENTION

The present invention relates to a sound recording and replaying technology, particularly to a method for recording and reconstructing a three-dimensional sound field.

### BACKGROUND OF THE INVENTION

Sound communication is very important for information exchange and emotional expression. With the prosperous development of multimedia industry, various sound recording apparatuses, such as recording pens, recorders and recording rooms, are progressing to record the sound field as truly as possible.

Simultaneously, various sound playing devices, such as household speakers, vehicular audio systems, theater surround audio systems, and earphones, are required to present higher and higher fidelity. Therefore, high-end sound field recording and replaying technology is always the target the related manufacturers are eager to achieve.

A Chinese patent publication No. CN101001485 disclosed a finite-sound source and multi-channel sound field system, which comprises a microphone array recording M-channel audio signals and detecting the characteristics of the sound field; an audio frequency collection subsystem transforming the moduli of audio signals in different channels, packaging the audio data, and labeling the channels and timings; a server processing the audio data of the microphones, separating and processing the sound sources, compressing and storing data, mixing the data of the sound sources and transforming the mixed data into the output data of N pieces of speakers according to the M-channel sound source information and the characteristics of the reconstructed sound field; an audio restoring subsystem arranging the data of different sound sources into multi-channel analog signals and synchronizing the multi-channel speakers; and a speaker array playing the N-channel audio signals. Thereby, the prior art separates and collects sound source signals, dynamically matches M and N in a weighted way, omnidirectionally and precisely reproduces the original sound field, reduces the distortion of sound field phases, and avoids the interference and other distortions in processing, amplifying and playing signals.

However, the abovementioned finite-sound source and multi-channel sound field system needs a particle filter to separate noise and interference and has to transform audio data in recording signals, which results in complicated processes. Further, the conventional technology needs to adjust the volumes of speakers in replaying signals, which makes it likely to lose fidelity and have a smaller sweet spot. Therefore, the conventional technology still has room to improve.

### SUMMARY OF THE INVENTION

The primary objective of the present invention is to solve the problem that the conventional sound field recording and replaying systems have disadvantages of complicated processes and a smaller sweet spot and are likely to lose fidelity.

To achieve the abovementioned objective, the present invention provide a method for recording a three-dimensional (3D) sound field, which is used to record a 3D sound field including a plurality of sound sources, and which comprises

Step 1: establishing a microphone array including a plurality of microphones in a 3D sound field, and letting the microphones receive sound waves emitted by sound sources and each having the characteristics of a plane wave;

Step 2: expressing the sound pressure detected by the microphones with

p(xₘ,ω)=s(ω)e^{jk}^{ₘ},m=1,2, . . . ,M, Equation (1):

and

p(ω)=a(k)s(ω), Equation (2):

wherein s(ω) is a Fourier Transform of a sound source signal, xₘ the position of the mth microphone, k a wave-number vector, and
wherein Equation (2) is a vector form of Equation (1), and
wherein a(k)=[e^{-jkx}^{₁} . . . e^{-jkx}^{_{M}}]^{T} is a multi-element vector array;

Step 3: using a direction of arrival (DOA) algorithm to track and locate the sound source signals, and obtaining an orientation expression of the sound source signal;

Step 4: using the orientation expression, a Tikhonov regulation method and a convex optimization method to work out the sound source signal.

To achieve the abovementioned objective, the present invention also proposes a method of using the sound source signal to reconstruct the 3D sound field in an area, which comprises

Step A: establishing a plurality of control points inside the area, and establishing a speaker array including a plurality of speakers outside the area;

Step B: using a plurality of sound waves each having the characteristics of a plane wave to form the 3D sound field, and expressing the relationship of the 3D sound field and the control points with

p=Bsₚ Equation (A):

B=[b₁ . . . bₚ] Equation (B):

bₚ==[e^{-jk}^{ₚ}^{y}^{₁} . . . e^{-jk}^{ₚ}^{y}^{ₙ}] Equation (C):

wherein p is the 3D sound field, sₚ a frequency-domain intensity vector of the sound source signal, bₚ a multi-element vector array of the pth sound wave to the control points, yₙ a position vector of the nth control point, B an aggregate matrix of all the multi-element vector arrays;

Step C: expressing a reconstructed sound field with

\hat{p}=Hsₛ Equation (D):

wherein sₛ=[s₁(ω) . . . s_{L}(ω)]^{T} is a frequency-domain intensity vector of a reconstructed sound source signal and H is a transfer function;

Step D: letting the reconstructed sound field approach the 3D sound field to obtain

minₛ_{ₛ}∥Bsₚ−Hsₛ∥=sₛ=H⁺Bsₚ, Equation (E):

and inputting the obtained sₛ into the speaker array to reconstruct the sound field.

Via the abovementioned technical scheme, the present invention has the following advantages:

1. The present invention uses the DOA algorithm in recording the sound field to track the sound sources and obtain the number and orientation of the sound sources and the separated sound sources, exempted from the complicated process of transforming the sound source signals.

2. The present invention establishes control points in the area in reconstructing the sound field and uses the control points and the characteristics of the sound field to work out the reconstructed sound field, exempted from building a speaker array identical to the original microphone array in shape and size, and greatly enlarging the width of the sweet spot.

3. The present invention truly records the orientations and signals of the sound sources in recording the sound field and involves the information in calculation in reconstructing the sound field. In replaying the sound field, the signal of each of the speakers has been ready. Therefore, it is unnecessary to adjust the volumes of the speakers. Thus, the present invention is exempted from the distortion of the reconstructed sound field, which is caused by adjusting the speakers.

### BRIEF DESCRIPTION OF THE DRAWINGS

FIG. 1 is a diagram schematically showing a method for recording a three-dimensional (3D) sound field according to one embodiment of the present invention; and

FIG. 2 is a diagram schematically showing a method for reconstructing a 3D sound field according to one embodiment of the present invention.

### DETAILED DESCRIPTION OF THE PREFERRED EMBODIMENTS

The technical contents of the present invention will be described in detail in cooperation with drawings below.

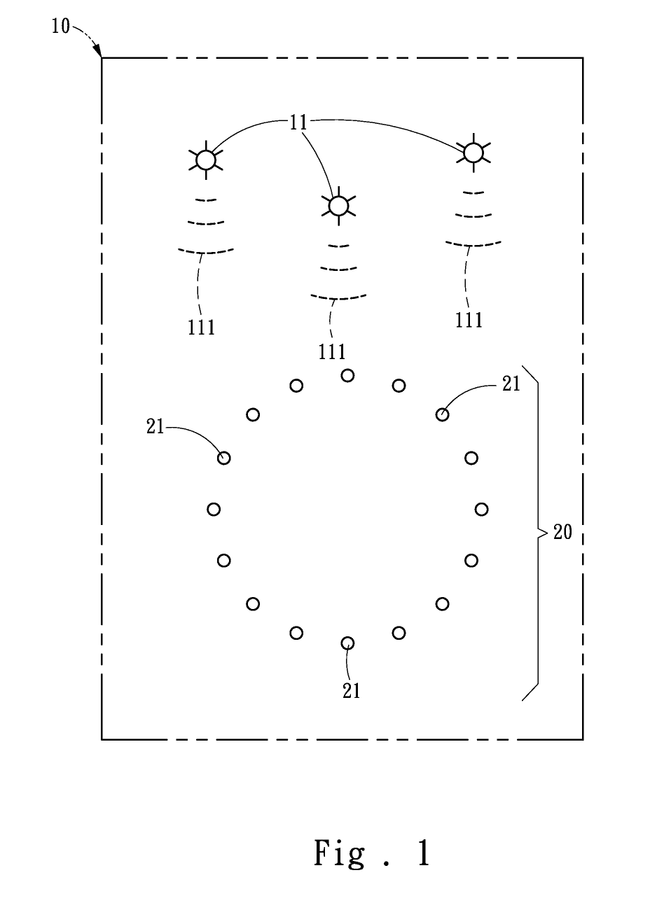

Refer to FIG. 1 a diagram schematically showing a method for recording a three-dimensional (3D) sound field according to one embodiment of the present invention. The recording method of the present invention is used to record a 3D sound field 10 including a plurality of sound sources 11. The method for recording a 3D sound field of the present invention comprises Steps 1-4.

In Step 1, establish a microphone array 20 including a plurality of microphones 21 in the 3D sound field 10, and let each microphone 21 receive sound waves 111 emitted by the sound sources 11 and each having the characteristics of a plane wave. In the embodiment shown in FIG. 1, the microphones 21 are arranged to have a circle shape. However, the present invention does not limit that the microphones must be arranged into a circle. In the present invention, the microphones may be arranged into other shapes.

In Step 2, express the sound pressure of the sound wave 111, which is detected by each microphone 21, with

p(xₘ,ω)=s(ω)e^{jk}^{ₘ},m=1,2, . . . ,M, Equation (1):

and

p(ω)=a(k)s(ω), Equation (2):

wherein s(ω) is a Fourier Transform of a sound source signal, xₘ the position of the mth microphone 21, k a wave-number vector, and
wherein Equation (2) is a vector form of Equation (1), and
wherein a(k)=[e^{-jkx}^{₁} . . . e^{-jkx}^{_{M}}]^{T} is a multi-element vector array.

In Step 3, use a direction of arrival (DOA) algorithm to track and locate the sound source signals, and obtain an orientation expression of the sound source signal. The DOA algorithm is a multiple signal classification method or a minimum variance distortionless response method. This embodiment of the present invention adopts the multiple signal classification method and obtains the orientation expressions:

$$\begin{matrix}{S}_{MUSIC} ( θ ) = \frac{1}{{a ( θ )}^{H} {P}_{N} a ( θ )} & Equation ( 3 ) \\ {θ}_{g} = arg {max}_{θ} {S}_{MUSIC} ( θ ) & Equation ( 4 )\end{matrix}$$

wherein S_{Music} (θ) is the frequency spectrum of the multiple signal classification method, θ_{S} the rotation angle, and P_{N} the matrix of the vectors projected to the noise subspace.

In Step 4, use the orientation expressions, a Tikhonov regulation method and a convex optimization method to work out the sound source signal. In this embodiment, Step 4 further includes Steps 4A-4C.

In Step 4A, let the 3D sound field 10 have N pieces of sound source signals, and undertake an inverse computation of Equation (2) to obtain

sₚ=A⁺p Equation (5):

wherein sₚ=[s₁(ω) . . . s_{N}]^{T} is the solution of the inverse computation of Equation (2) and A=[a₁ . . . a_{N}]^{T} is the multi-element set of the N pieces of estimated orientations of the sound source signals.

In Step 4B, let N be smaller than M and let A be a singular matrix to solve an ill-conditioned problem; use the Tikhonov regulation method to obtain

min∥Asₚ−p∥²+β∥sₚ∥² Equation (6):

and

ŝₚ=(A^{H}A+βI)⁻¹A^{H}p Equation (7):

wherein β is a regulation parameter and ŝₚ is the retrieved sound signal.

In Step 4C, regard the microphone array 20 as a sensing standard and regard the multi-element vector array as an expressing standard, and use a compressive sensing method to simply Equations (6) and (7) and obtain

min_{δ}∥ŝ∥₁st.∥Qŝ−p∥₂≦δ Equation (8):

wherein δ is the boundary value of the constant and Q=[a₁ . . . a_{N}] is the matrix of the DOA algorithm. Then, use the convex optimization method to form a convex optimization form. Then, work out the sound signal S and record the 3D sound field.

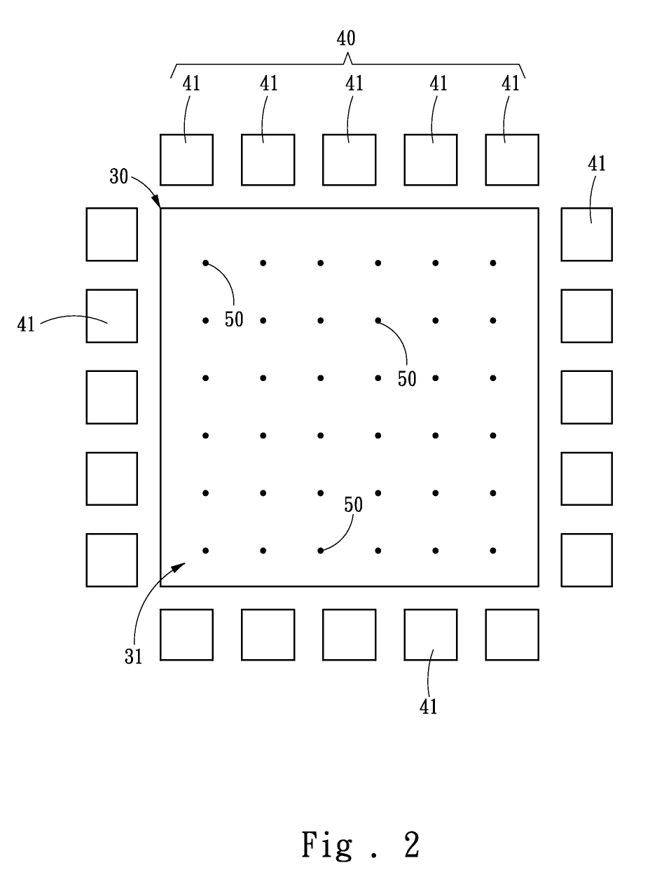

Refer to FIG. 2 a diagram schematically showing a method for reconstructing a 3D sound field according to one embodiment of the present invention. The present invention further proposes a method of using a sound source signal to reconstruct a 3D sound field. The sound source signal is recorded in the 3D sound field 10 and used to establish a reconstructed sound field 31 in an area 30. The reconstructing method of the present invention comprises Steps A-D.

In Step A, establish a plurality of control points 50 inside the area 30, and establish a speaker array 40 including a plurality of speakers 41 outside the area 30.

The control points 50 inside the area 30 respectively have their own orientations.

The speakers 41 are selectively arranged in the surrounding of the area 30.

In Step B, form the 3D sound field 10 with a plurality of sound waves 111 each having the characteristics of a plane wave, and express the relationship between the 3D sound field 10 and the control points 50 with

p=Bsₚ Equation (A):

B=[b₁ . . . bₚ] Equation (B):

bₚ==[e^{-jk}^{ₚ}^{y}^{₁} . . . e^{-jk}^{ₚ}^{y}^{ₙ}] Equation (C):

wherein p is the 3D sound field 10, sₚ the frequency-domain intensity vector of the sound source signal, bₚ the multi-element vector array of the pth sound wave 111 to the control points 50, yₙ the position vector of the nth control point 50, B the aggregate matrix of all the multi-element vector arrays.

In Step C, express the reconstructed sound field 31 with

\hat{p}=Hsₛ Equation (D):

wherein sₛ=[s₁(ω) . . . s_{L}(ω)]^{T} is the frequency-domain intensity vector of the reconstructed sound field 32, i.e. the signal for the speaker 42; H is the transfer function. The signal for the speaker 42 may be regarded as a point sound source whose sound wave has the characteristic of a spherical wave. Therefore, the signal for the speaker 42 may be expressed by a Green's function

$${\{ H \}}_{nl} = \frac{{e}^{- j {kr}_{nl}}}{{r}_{nl}} , \\ {r}_{nl} = ‖ {y}_{n} - {y}_{l} ‖ , \qquad Equation ( D 1 )$$

wherein {H}ₙₗ is a Green's function, and r, the distance from each control point to each speaker.

In Step D, let the reconstructed sound field 31 approach the 3D sound field 10, and undertake an inverse computation to obtain

minₛ_{ₛ}∥Bsₚ−Hsₛ∥=sₛ=H⁺Bsₚ Equation (E):

wherein H⁺ is the pseudo-inverse matrix of H. The solution can be obtained with a truncated singular value decomposition method. Then, the acquired signal sₛ of each speaker is input into the speaker array 40 to establish the reconstructed sound field 31.

In conclusion, the present invention proposes a method for recording a 3D sound field and a method of using a sound source signal to reconstruct a 3D sound field and uses them to combine a microphone array and a speaker array to form an integrated array able to record and replay a 3D sound field. The present invention at least has the following advantages:

1. The present invention can directly obtain the number and orientations of the sound sources and the separated sound sources, exempted from the complicated process of transforming the sound source signals.
2. The present invention needn't build a speaker array identical to the original microphone array in shape and size and greatly enlarges the width of the sweet spot.
3. In replaying, the signal for each of the speakers has been ready. Therefore, it is unnecessary to adjust the volumes of the speakers. Thus, the present invention is exempted from the distortion of the reconstructed sound field, which is caused by adjusting the speakers.
4. The present invention can present an identical 3D sound field in different areas and make the listeners seem to be situated in the original 3D sound field.

Therefore, the present invention possesses utility, novelty and non-obviousness and meets the condition for a patent. Thus, the Inventors file the application for a patent. It is appreciated if the patent is approved fast.

The present invention has been described in detail with the abovementioned embodiments. However, these embodiments are only to exemplify the present invention but not to limit the scope of the present invention. Any equivalent modification or variation according to the spirit of the present invention is to be also included within the scope of the present invention.

What is claimed is:

1. A method for recording a three-dimensional (3D) sound field, used to record a 3D sound field including a plurality of sound sources, and comprising
Step 1: establishing a microphone array including a plurality of microphones in a 3D sound field, and letting each microphone receive sound waves emitted by the sound sources and each having characteristics of a plane wave;
Step 2: expressing a sound pressure of the sound wave, which is detected by each microphone, with
p(xₘ,ω)=s(ω)e^{jk}^{ₘ},m=1,2, . . . ,M, Equation (1):
and
p(ω)=a(k)s(ω), Equation (2):
wherein s(ω) is a Fourier Transform of a sound source signal, xₘ a position of an mth microphone, k a wave-number vector, and
wherein Equation (2) is a vector form of Equation (1), and
wherein a(k)=[e^{-jkx}^{₁} . . . e^{-jkx}^{_{M}}]^{T} is a multi-element vector array;
Step 3: using a direction of arrival (DOA) algorithm to track and locate the sound source signals, and obtaining an orientation expression of the sound source signal; and
Step 4: using the orientation expression, a Tikhonov regulation method and a convex optimization method to work out the sound source signal.

2. The method for recording a 3D sound field according to claim 1, wherein in Step 3, the DOA algorithm includes a multiple signal classification method, and wherein the multiple signal classification method is used to obtain the orientation expressions:
$$\begin{matrix}{S}_{MUSIC} ( θ ) = \frac{1}{{a ( θ )}^{H} {P}_{N} a ( θ )} , and & Equation ( 3 ) \\ {θ}_{g} = arg {max}_{θ} {S}_{MUSIC} ( θ ) , & Equation ( 4 )\end{matrix}$$
wherein S_{MUSIC} (θ) is a frequency spectrum of the multiple signal classification method, θ_{S} a rotation angle, and P_{N} a matrix of the vectors projected to a noise subspace.

3. The method for recording a 3D sound field according to claim 2, wherein Step 4 includes
Step 4A: letting the 3D sound field comprising N pieces of sound source signals, and undertaking an inverse computation of Equation (2) to obtain
sₚ=A⁺p Equation (5):
wherein sₚ=[s₁(ω) . . . s_{N}(ω)]^{T} is a solution of the inverse computation of Equation (2), and A=[a₁ . . . a_{N}]^{T} is a multi-element set of N pieces of estimated orientations of the sound source signals.
Step 4B: letting N be smaller than M, and using the Tikhonov regulation method to obtain
min∥Asₚ−p∥²+β∥sₚ∥², Equation (6):
and
ŝₚ=(A^{H}A+βI)⁻¹A^{H}p Equation (7):
wherein β is a regulation parameter and sₚ is a retrieved sound signal;
Step 4C: using a compressive sensing method to simply Equations (6) and (7) and obtain
min_{δ}∥ŝ∥₁st.∥Qŝ−p∥₂≦δ Equation (8):
wherein δ is a boundary value of a constant, and Q=[a₁ . . . a_{N}] is a matrix of the DOA algorithm, and using the convex optimization method to work out the sound source signal, wherein the sound source signal is expressed by ŝ.

4. A method of using the sound signals in claim 1 to reconstruct the 3D sound field, used to reconstruct a sound field in an area, and comprising
Step A: establishing a plurality of control points inside an area, and establishing a speaker array including a plurality of speakers outside the area;
Step B: forming the 3D sound field with a plurality of sound waves each having characteristics of a plane wave, and expressing a relationship between the 3D sound field and the control points with
p=Bsₚ Equation (A):
p=Bsₚ Equation (A):
and
bₚ==[e^{-jk}^{ₚ}^{y}^{₁} . . . e^{-jk}^{ₚ}^{y}^{ₙ}] Equation (C):
wherein p is the 3D sound field, sₚ a frequency-domain intensity vector of the sound source signals, bₚ a multi-element vector array of the pth sound wave to the control points, yₙ the position vector of the nth control point, B the aggregate matrix of all the multi-element vector arrays;
Step C: expressing the reconstructed sound field with
\hat{p}=Hsₛ, Equation (D):
wherein sₛ=[s₁(ω) . . . s_{L}(ω)]^{T} is a frequency-domain intensity vector of the reconstructed sound field, and H is a transfer function; and
Step D: letting the reconstructed sound field approach the 3D sound field to obtain
minₛ_{ₛ}∥Bsₚ−Hsₛ∥=sₛ=H⁺Bsₚ, Equation (E):
and inputting the acquired sₛ into the speaker array to establish the reconstructed sound field.

5. The method of using the sound signal to reconstruct the 3D sound field according to claim 4, wherein in Step D, sₛ is obtained with a truncated singular value decomposition method.
